(19) United States
(12) Patent Application Publication
(10) Pub. No.: US 2022/0392754 A1
(43) Pub. Date: Dec. 8, 2022

(54) MASS SPECTROMETER AND METHOD FOR CALIBRATING A MASS SPECTROMETER

(71) Applicant: Leybold GmbH, Köln (DE)

(72) Inventors: Leonid Gorkhover, Ulm (DE); Yessica Brachthäuser, Wuppertal (DE)

(21) Appl. No.: 17/770,199

(22) PCT Filed: Oct. 22, 2019
(86) PCT No.: PCT/EP2019/078764

§ 371 Date: Apr. 19, 2022

(51) Int. Cl. H01J 49/00; H01J 49/10

(52) U.S. Cl. CPC H01J 49/0009; H01J 49/10

(57) ABSTRACT

The invention relates to a mass spectrometer, having: a gas inlet adapted to supply a sample gas to be ionized to an ionization region of the mass spectrometer, a calibration unit adapted to supply a calibration gas to be ionized to the ionization region, and an ionization unit adapted to ionize the sample gas and/or the calibration gas in the ionization region. The calibration unit includes at least one evaporation source for generating the calibration gas by evaporating a source material. The invention also relates to a method for calibrating a mass spectrometer.

### CROSS-REFERENCE OF RELATED APPLICATION

This application is a Section 371 National Stage Application of International Application No. PCT/EP2019/078764, filed Oct. 22, 2019, which is incorporated by reference in its entirety and published as WO 2021/078368 A1 on Apr. 29, 2021.

### FIELD

The invention relates to a mass spectrometer and to a method for calibrating a mass spectrometer.

### BACKGROUND

Calibration of the mass scale and of the signal intensity/sensitivity of a mass spectrometer is generally performed by introducing calibration gases into a vacuum system of the mass spectrometer via a gas inlet. A calibration gas is typically composed of constituents with known atomic masses or (equivalently) mass-to-charge (m/z) ratios. The known atomic masses of the constituents of the calibration gas produce one or more calibration peaks in the resulting mass spectrum, corresponding to the mass-to-charge ratio(s) of the constituent(s) of the calibration gas. As the constituents of the calibration gas are known, the calibration peaks may serve as a mass scale by which the mass-to-charge ratios of peaks corresponding to unknown constituents of a sample gas can be determined.

For quantitative measurements, the signal intensity that is detected by the mass spectrometer at a specific m/z ratio has to be correlated with the number of ions or with the partial pressure of the corresponding constituent of the sample gas. For this purpose, the sensitivity of the mass spectrometer for a specific m/z ratio has to be determined when calibrating the mass spectrometer. For this purpose, a calibration process as described e.g. in the article “Methods for in situ QMS calibration for partial pressure and composition analysis” by Robert E. Ellefson, Vacuum 101 (2014) 423-432, may be performed.

Introduction of calibration gases into a mass spectrometer typically causes costs for additional gas inlet systems. However, in many UHV(ultra-high vacuum)- or XHV(extreme high vacuum)-systems, an additional gas inlet is generally undesirable. Moreover, calibration gases may cause contamination of the mass spectrometer, more specifically of the vacuum system of the mass spectrometer.

The heaviest volatile non-radioactive element of the periodic table is xenon, having several isotopes with atomic masses ranging from 124 to 136 a.m.u. The mass scale of the mass spectrometer may therefore be calibrated only up to a maximum of 136 a.m.u. when using a calibration gas that consists of a volatile (non-radioactive) chemical element. Moreover, lighter isotopes of Xe may cause interference when performing the calibration. Due to the existence of several isotopes, Xe is also of limited suitability for calibrating the signal intensity/determining the sensitivity of the mass spectrometer: On the one hand, signal intensities of Xe isotopes having different a.m.u. have to be measured in a timely manner, on the other hand, fractions of the different Xe isotopes in the calibration gas have to be known beforehand (well-defined).

Calibration of the mass scale above 150 a.m.u. is complicated, as molecules or atoms with such large atomic masses are either non-volatile or have low volatility. Larger molecules, e.g. organic molecules or molecules such as SF₆, are fragmented during ionization and therefore generate ionized fragmentation products having several different, smaller atomic masses. Under the respective measurement conditions, the proportions of these fragmentation products have to be determined or have to be known, complicating the calibration process. Moreover, practically all organic molecules having masses above 150 a.m.u. such as dodecane (C₁₂H₂₆, 170 a.m.u.) or the like are deposited on vacuum components of the mass spectrometer and its environment as contaminants and may only be removed at increased temperatures, taking considerable time. One example of strong need of good calibration in the range of 200 a.m.u. are the widely used quadrupole mass spectrometers (QMS). These are known for their discrimination of signals of higher masses, what is highly depending on different factors like prehistory, environment, temperature and so on.

U.S. Pat. No. 4,847,493 discloses an apparatus and a method for calibrating a mass spectrometer. A calibration gas tank is located inside the same housing that contains the ion source assembly and the analyzing section of the mass spectrometer. Each of the calibration gas and of the sample gas communicates with its own associated valve. The two valves control the flow of a selected one of the sample gas and the calibration gas to the ion source assembly.

U.S. Pat. No. 6,797,947 B2 discloses an apparatus and a method for calibrating a mass spectrometer by internally introducing calibration (lock) masses at a post-source stage of the mass spectrometer. The mass calibration apparatus comprises an ion source for providing analyte ions to a mass analyzer, ion optics, situated between the ion source and the mass analyzer, and a source of lock mass ions including a lock mass source and a lock mass ionization source adjacent the ion optics for creating lock mass ions within the ion optics.

The discussion above is merely provided for general background information and is not intended to be used as an aid in determining the scope of the claimed subject matter. The claimed subject matter is not limited to implementations that solve any or all disadvantages noted in the background.

### SUMMARY

One aspect of the invention relates to a mass spectrometer, comprising: a gas inlet adapted to supply a sample gas to be ionized to an ionization region of the mass spectrometer, a calibration unit adapted to supply a calibration gas to be ionized to the (same) ionization region, and an ionization unit adapted to ionize the sample gas and/or the calibration gas in the ionization region, wherein the calibration unit comprises at least one evaporation source for generating the calibration gas by evaporating a source material. As usual, the mass spectrometer also comprises an analyzing section. The analyzing section comprises a mass analyzer/mass filter for selecting specific mass-to-charge ratios of the sample/calibration gas, and a detector for detecting the ionized sample gas and/or calibration gas.

The calibration unit, more specifically the evaporation source, is typically located in the same housing that contains the ionization unit and the analyzing section. During calibration, the calibration gas is ionized in the ionization region by the ionization unit, typically by providing an ionizing energy input/radiation (e.g. electrons, laser radiation, . . . ) and at least part of the calibration gas is ionized. The ions of the calibration gas are processed in the mass spectrometer in the same way as the sample gas (analyte), i.e. they are detected by a detector of the mass spectrometer after passing the mass analyzer.

Due to the generation of the calibration gas by evaporation of the source material in the evaporation source, no additional gas inlet system for supplying the calibration gas to the ionization region is required. Moreover, the source material may be a chemical element having more than 136 a.m.u., for instance a metallic material, which is non-volatile under standard conditions. A calibration gas consisting of atoms of such a chemical element is not fragmented during ionization, thus simplifying the calibration for large atomic masses up to approx. 200 a.m.u. The calibration may be further simplified when a source material in the form of a specific isotope of a chemical element or in the form of a chemical element having only one stable isotope, e.g. ²⁷Al or ¹⁹⁷Au, is used. Moreover, it is possible to use source materials for the calibration that have a sticking probability that is close to 1 on the surfaces of vacuum components of the mass spectrometer being made e.g. of stainless steel. In this case, atoms of the source material that are deposited on the vacuum components after the calibration stick to the surfaces of the vacuum components that are affected by the calibration gas and do not contaminate other parts of the mass spectrometer and the vacuum system the mass spectrometer is attached to.

In one embodiment, the evaporation source, more precisely the source material, and the ionization region are arranged along a line of sight, i.e. along a straight line that is in general not blocked by any components of the mass spectrometer. In this way, the calibration gas can be supplied from the evaporation source to the ionization region as a beam that propagates basically along a straight line. This is advantageous, as the calibration gas typically comprises only neutral atoms or molecules and therefore cannot be deflected by ion optics or the like before reaching the ionization region. It is also possible that the calibration unit or the evaporation source are arranged inside of the ionization unit, in particular when the ionization unit encloses the ionization region (at least in part).

In a further embodiment, the evaporation source is a thermal evaporation source, preferably a resistive evaporation source, an electron beam evaporation source or an effusion evaporation source. In a thermal evaporation source, the source material is heated to temperatures close to the melting or boiling point, thus transferring the source material into the gaseous phase. In a resistive evaporation source, a high current is passed through a resistive element such as a filament, a resistive boat or a crucible where the source material is placed. In an electron beam evaporation source the source material is heated directly using a focused beam of high energy electrons. An effusion evaporation source typically comprises a crucible that contains the source material in solid form, a heating wire, a cooler and a thermocouple to control the temperature of the source material.

In one development, the resistive evaporation source comprises a heated filament that is at least partially coated with the source material. For providing the coating, a few pieces of the source material, typically in the form of a metal wire (e.g. made of gold or aluminum), are hooked to the filament. When heating the filament, the metal wire will melt and flow along the filament, like solder on a soldering iron, producing a coating, e.g. in the form of droplets of the source material. When such a filament is heated, the source material evaporates from the heated filament, the latter being made e.g. of tungsten.

In a further embodiment, the evaporation source is a pulsed laser deposition, PLD, evaporation source. In pulsed laser deposition, a high-power pulsed laser beam is focused inside a vacuum chamber to strike a target of the source material that is ablated by the laser beam and vaporized from the target (typically in a plasma plume).

In a further embodiment, the source material is a metal, preferably selected from the group consisting of: Al, Co, Mn, Bi, Ni, Fe, Cu and precious metals, in particular Au. Au has been proven to be particularly suitable as a source of atoms of the calibration gas, as it has a high atomic mass and only a single stable isotope at 197 a.m.u. However, other metals may also be used as a source material, in particular chemical elements having a single stable isotope such as Al or the like. As a rule, chemical elements having a saturation vapor pressure higher than that of lead (Pb) should be avoided as a source material (if not being used in the vacuum system anyhow), as these source materials may contaminate the vacuum system of the mass spectrometer, in particular vacuum components such as vacuum ducts, vacuum housings or the like.

In a further embodiment, the source material is selected from the group consisting of: metal nitrides and metal oxides, in particular nitrides and oxides of Tantalum, Vanadium, Tungsten, Rhenium, or Yttrium. Chemical compounds other than nitrides and oxides may serve as the source material of the evaporation source as well. As indicated above, in particular chemical elements or compounds that have a high sticking probability on the surfaces of the vacuum components of the mass spectrometer are preferred source materials.

In a further embodiment, the mass spectrometer comprises at least one sensor, preferably for determining a pressure of the calibration gas (or a background pressure), wherein the sensor is preferably arranged along a line of sight with the ionization region and/or along a line of sight with the source material. The sensor may be used to control or regulate an evaporation rate of the source material. For this purpose, the at least one sensor may be in signal communication with a control unit that is typically part of the mass spectrometer. The control unit is a programmable device in the form of suitable hardware and/or software, e.g. a microprocessor, a programmable controller, a computer or another electronic device. The control unit may be integrated into the calibration unit or may be arranged at another location in the mass spectrometer.

In one development, the sensor is a pressure sensor, preferably is an ionization vacuum gauge, more preferably a cold cathode vacuum gauge, in particular a Penning vacuum gauge, or a hot cathode vacuum gauge, in particular a Bayard-Alpert vacuum gauge or an extractor ionization gauge. Ionization vacuum gauges are used to measure gas pressure by ionization of the residual gas, in the present case the calibration gas or a background gas contained in the mass spectrometer. A hot cathode or a cold cathode is used to generate electrons for ionizing the (residual) gas supplied to such a pressure sensor through electron beam ionization. Use of an ionization vacuum gauge such as a Penning vacuum gauge, Bayard-Alpert vacuum gauge or extractor vacuum gauge is particularly advantageous when the ionization unit is adapted to ionize the sample gas and/or the calibration gas by electron impact ionization, i.e. when the ionization unit uses the same type of ionization as the ionization vacuum gauges, in particular with similar ionization cross sections for different atoms. Alternatively, a piezoelectric sensor may be used as a pressure sensor to measure the pressure in the environment of the pressure sensor based on the piezoelectric effect.

In one development, the pressure sensor or a control unit is adapted for determining a flow rate of the calibration gas based on the pressure of the calibration gas. For this purpose, an ionization vacuum gauge such as the Bayard-Alpert ionization vacuum gauge may be used. Such a vacuum gauge (gauge head) is typically used as a beam flux monitor in Molecular Beam Epitaxy to determine the flow rate of atoms form a source such as an effusion evaporation source (see e.g. www.mbe-komponenten.de/products/pdf/data-sheet-bfm.pdf). Such a beam flux monitor based on the Bayard-Alpert ionization gauge allows to determine a beam equivalent pressure (BEP) of atomic or molecular beams. The Beam Equivalent Pressure is a local pressure of a directional gas beam on a surface, measured by the pressure gauge. The Bayard-Alpert ionization gauge or another type of ionization vacuum gauge thus allows both determining the signal intensities of the mass spectrometer during mass spectrometric analysis of a sample gas or gas mixture as described in the article by Robert E. Ellefson cited above, and the determination/supervision/calibration of the sensitivity of the mass spectrometer for atoms of the evaporation source(s).

In a further embodiment, the sensor is a quartz crystal microbalance (QCM), preferably for determining (and possibly controlling) a flow rate of the calibration gas. The flow of the calibration atoms or molecules can be measured or controlled by use of such sensor, well known in thin film deposition. The atoms or molecules of the calibration gas having high sticking probability on the sensor build a thin film on the QCM sensor, thus changing the resonance frequency of the QCM sensor with a rate corresponding to the flow rate of the atoms or molecules of the calibration gas. Therefore, the QCM sensor allows to determine the flow rate of the atoms or molecules of the calibration gas directly, i.e. without determining the pressure of the calibration gas.

In a further development, the mass spectrometer comprises a movable cover for blocking a line of sight between the source material and the ionization region and/or a line of sight between the source material and the pressure sensor. The movable cover can typically be moved from a first position in which the cover does not block the line of sight between the source material and the ionization region/pressure sensor and a second position in which the movable cover blocks the respective line of sight. The movement of the cover between the two positions may be a translational and/or rotational movement. By blocking the respective line of sight, the flow of the calibration gas from the calibration unit to the ionization region/the pressure sensor is essentially obstructed. In this way, the at least one pressure sensor can be used to determine a pressure increase in the vacuum system of the mass spectrometer when the evaporation source is heated up without simultaneously measuring the pressure increase due to the flow of the calibration gas. In addition, the moveable cover may provide a gastight seal of the calibration unit or the evaporation source from the remainder of the mass spectrometer.

In a further embodiment, the ionization unit comprises an electron ionization source (or consists of an electron ionization source). An electron ionization source ionizes the atoms or molecules of the sample gas and/or of the calibration gas by electron bombardment. The electron ionization source may be implemented e.g. as an electron gun or the like. One skilled in the art will appreciate that the ionization unit may be adapted to perform the ionization in a different way, e.g. by an inductively coupled plasma, ICP, by glow discharge ionization, etc. Depending on the type of ionization unit, the ionization region may be exterior to the ionization unit, as is the case with an electron gun, or the ionization region may be part of the ionization unit, i.e. the ionization unit may at least partially surround the ionization region.

In a further embodiment the mass spectrometer comprises an ion trap for storing ions of the sample gas and/or of the calibration gas, wherein the ionization region is formed inside of the ion trap (in a storage region for ions). The mass spectrometer may in particular be a Fourier-Transform (Ion Cyclotron Resonance) mass spectrometer. In an FT ion trap mass spectrometer, in addition to storing ions in the storage region of the ion trap, the ions are excited in the storage region (mass selection) and are detected in the FT ion trap, more specifically at the electrodes of the ion trap. The ionization region is preferably located in the center of the ion trap. In this case, the line of sight between the source material and the ionization region typically leads from the source material to the center of the ion trap.

A further aspect of the invention relates to a method for calibrating a mass spectrometer, comprising: generating a calibration gas by evaporating a source material in at least one evaporation source of the mass spectrometer, supplying the calibration gas to an ionization region and ionizing the calibration gas in the ionization region, detecting the ionized calibration gas in a detector of the mass spectrometer, and calibrating the mass spectrometer based on the detected ionized calibration gas. As indicated above, the ions of the calibration gas are supplied to the ionization region and are processed in the mass spectrometer in the same way as the sample gas (analyte), i.e. they are detected by a detector of the mass spectrometer, typically after passing a mass analyzer that may be embodied as an excitation device when the mass spectrometer comprises an ion trap.

As indicated above, the calibration gas may allow to determine the mass scale of the mass spectrometer. For instance, when the mass spectrometer comprises a quadrupole analyzer, the correlation between the applied quadrupole voltages and the mass-to-charge ratios may be calibrated/determined, allowing to identify specific chemical elements by their mass-to-charge ratio in the respective mass spectra. A similar calibration may be performed in a Time-of-Flight mass analyzer wherein a translation between ion drift time and mass-to-charge ratios may be calibrated.

In one variant, the step of calibrating the mass spectrometer comprises: determining a sensitivity of the mass spectrometer based on a signal intensity when detecting the ionized calibration gas and based on a pressure detected by a pressure sensor when supplying the calibration gas to the ionization region. In addition to the mass scale, it is advantageous to also determine/calibrate the sensitivity of the mass spectrometer, e.g. both for small and large atomic masses. The calibration of the sensitivity of the mass spectrometer may be performed as indicated in the article by Robert E. Ellefson that has been cited above and is incorporated by reference to this application in its entirety.

For instance, for determining the sensitivity of the mass spectrometer, in a first step, the background pressure p₀ and the signal intensity Bₖ at the mass-to-charge ratio(s) k of interest, i.e. at the mass-to-charge ratio(s) of the source material, are determined before supplying the calibration gas to the ionization region. In a second step, the source material is evaporated to produce the calibration gas and a signal intensity Sₖ at the mass-to-charge ratio(s) k of the source material and the pressure p₁ of the calibration gas in addition to the background pressure are determined a second time. The sensitivity Kₖ may be determined by calculating the ratio of the difference between the signal intensities in the first and second step Sₖ−Bₖ at the mass-to-charge ratio(s) of interest k and the difference between the pressure values p₁−p₀ in the second step and in the first step:

Kₖ=(Sₖ−Bₖ)/(p₁−p₀) (1)

In this way, the sensitivity Kₖ for a respective mass-to-charge ratio k, e.g. for k=27 (Al) or for k=197 (Au) may be determined/calibrated.

Different evaporation sources having different source materials may be used for calibrating the mass spectrometer at different mass-to-charge ratios. One skilled in the art will appreciate that equation (1) given above is used for explaining the basic principle of calibrating the sensitivity of the mass spectrometer. In practice, further steps may be required during the calibration in order to take into account different effects, that are typically for evaporation of metals. One of such effects are getter effects of the surfaces coated with the fresh films consisting of atoms of the calibration gas, especially Al, Ti, Ta and other getter metals resulting in pressure decrease of other gases. On the other hand, pressure increases occur when heating the evaporation sources due to enhanced desorption of molecules from surrounding parts at elevated temperatures.

In one variant, the method further comprises: before and/or after supplying the calibration gas to the ionization region: coating surfaces of vacuum components in the mass spectrometer with a getter material for the source material. Suitable getter materials for the source materials typically used in the present applications are e.g. Al or Ti. In order to avoid peeling off of the source material from the surfaces of the vacuum components where deposits of the source material are formed, these surfaces may be coated with a getter material. The coating may be applied to the affected surface(s) by supplying the getter material to the affected surface(s) by using a further evaporation source for evaporation of the getter material. The coating with the getter material may be applied before a subsequent calibration, or possibly after a calibration in order to prepare for a subsequent calibration.

Other features and advantages of the invention will be apparent from the following detailed description, and from the claims.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are shown in the diagrammatic drawing and are explained in the description below. The following are shown:

FIG. 1 a schematic illustration of an example of a mass spectrometer having a calibration unit with an evaporation source for generating a calibration gas by evaporation of a source material,

FIG. 2 a schematic illustration of an ion trap mass spectrometer having a calibration unit similar to the one shown in FIG. 1,

FIG. 3a-c schematic illustrations of a resistive evaporation source and of a filament being partially coated with the source material.

### DETAILED DESCRIPTION

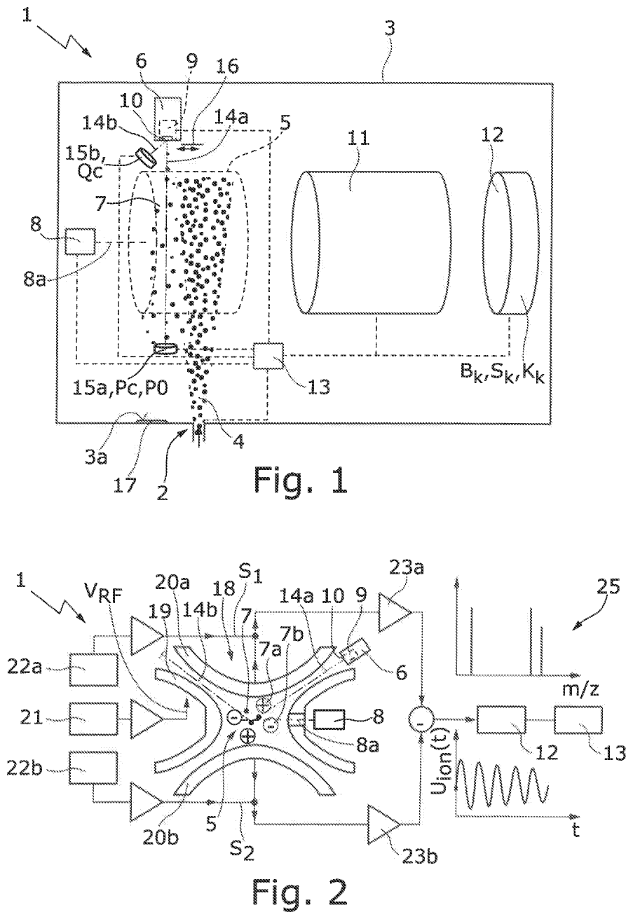

FIG. 1 schematically shows a mass spectrometer 1 having a gas inlet 2 (more precisely, a gas inlet system) for supplying a sample gas 4 from a process chamber outside of a (vacuum) housing 3 of the mass spectrometer 1 to an ionization region 5 inside of the housing 3 of the mass spectrometer 1. The mass spectrometer 1 has a calibration unit 6 adapted to supply a calibration gas 7 to the ionization region 5 of the mass spectrometer 1. The calibration unit 6 is arranged inside of the housing 3 of the mass spectrometer 1 (i.e. in-situ). An ionization unit 8 is also provided in the housing 3 and is adapted to ionize both the sample gas 4 (the analyte) and the calibration gas 7 in the ionization region 5.

In the present example, the ionization unit 8 is an electron ionization source in the form of an electron gun and generates an electron beam 8a that is directed to the ionization region 5 for ionizing the respective gases 4, 7 by electron impact ionization. The sample gas 4 and the calibration gas 7 are provided to the ionization region 5, i.e. the sample gas 4 and the calibration gas 7 may be provided to the ionization region 5 at the same time, but are typically not provided to the ionization region 5 at the same time. The sample gas 4 having typically unknown constituents and/or unknown amounts of constituents is provided to the ionization unit 5 for mass-spectrometric analysis thereof. The calibration gas 7 is provided to the ionization region 5 for calibration of the mass spectrometer 1.

After (partial) ionization in the ionization region 5, both the sample gas 4 and the calibration gas 7 are provided to an analysing section of the mass spectrometer 1. The analysing section has an analyzer 11, in the present example in the form of a quadrupole mass filter, for selecting a suitable range of mass-to-charge ratios of the constituents of the sample gas 4 or of the calibration gas 7. The analysing section also has a detector 12 for performing a mass spectrometric measurement of the ionized gases 4, 7. It will be understood that other types of analyzers, such as Time-of-Flight analyzers, sector field analyzers, etc. may be used in the mass spectrometer 1. The detector 12 may comprise a plurality of detector elements such as Faraday cups or the like.

For the purpose of selectively supplying the sample gas 4 or the calibration gas 7 to the ionization region 5, a control unit 13 is provided in the mass spectrometer 1. The control unit 13 may be adapted to control the gas inlet 2, e.g. a controllable valve or the like, to either supply the sample gas 4 to the ionization region 5 or to block the flow of the sample gas 4 to the ionization region 5. One skilled in the art will appreciate that the gas inlet 2 does not necessarily has a controllable valve. In this case, the sample gas 4 may be provided to the ionization region 5 in a continuous manner. One skilled in the art will also appreciate that the housing 3 may possibly be dispensed with. The control unit 13 is also adapted to control the calibration unit 6 to supply the calibration gas 7 to the ionization region 5 or to avoid generation of the calibration gas 7. In the present example, the calibration unit 6 has a single evaporation source 9 for generating the calibration gas 7 by evaporating a source material 10. In the example shown in FIG. 1, the evaporation source 9 is a thermal evaporation source in the form of a resistive evaporation source, a current being passed through a resistive element, e.g. a filament, where the source material 10 is placed, as will be described in detail below. The calibration unit 6 may also comprise other types of thermal evaporation sources e.g. an electron beam evaporation source, an effusion evaporation source, etc.

As can be gathered from FIG. 1, the source material 10 and the ionization region 5 (or the ionization volume) are arranged along a line of sight 14a. More precisely, the line of sight 14a extends from the source material 10 in a straight line that corresponds to the main flow direction of the calibration gas 7 and intersects the electron beam 8a generated by the ionization unit 8 in the ionization region 5.

The source material 10 is typically a non-volatile material, in particular a metal. Suitable metals are precious metals, in particular gold (Au), but other metals may be used as well as the source material 10, e.g. Al, Co, Mn, Bi, Ni, Fe, Cu, etc.

By evaporating a source material 10 in the form of a metal, a calibration gas 7 comprising atoms of the source material 10 is provided. A calibration gas 7 in the form of atoms of a metal vapour is not fragmented during ionization, simplifying the calibration process. However, the choice of the source material 10 is not limited to metals. For instance, chemical compounds such as metal nitrides or metal oxides, e.g. nitrides or oxides of Vanadium, Rhenium or Tantalum, Tungsten or Yttrium may be provided as the source material as well. Moreover, the calibration unit 6 may have more than one evaporation source 9 for evaporating different source materials 10. The calibration gases 7 associated with these evaporation sources 9 may be provided to the ionization region 5 simultaneously, possibly together with the sample gas 2.

Preferred source materials 10 for the calibration unit 6 have a high sticking probability for the surfaces of vacuum components of the mass spectrometer 1 that come into contact with the calibration gas 7, e.g. for the surface 3a at the interior of vacuum housing 3 of the mass spectrometer 1 that is typically made of stainless steel. In this way, deposits of the source material 10 on a respective surface 3a stick to that surface 3a and do not contaminate the mass spectrometer 1. In order to avoid a peeling off of the source material 10 from the affected surfaces 3a, these surfaces 3a may be coated with a getter material 17 for the source material 10, e.g. Al or Ti, either before or after supplying the calibration gas 7 to the ionization region 5.

In the example shown in FIG. 1, the mass spectrometer 1 comprises two sensors 15a, 15b that are not required, but helpful for operation of the mass spectrometer 1 with the calibration unit 6. The first sensor 15a is a pressure sensor arranged along the line of sight 14a with the ionization region 5 and with the source material 10. The pressure values p₁ and p₀ mentioned above can be determined with the first sensor 15a. Additionally, the pressure of the sample gas 4 can be measured with the first sensor 15a as well, provided that the first sensor 15a is arranged at a suitable position in the gas flow of the sample gas 4.

The second sensor 15b is arranged along a (further) line of sight 14b to the source material 10. The second sensor 15b allows for direct control/measurement of the flow rate Q_{c} of the calibration gas 7. For this purpose, the second sensor 15b is a quartz crystal microbalance. Alternatively, a pressure sensor like a Bayard-Alpert vacuum gauge may be used for this purpose as well. Other types of vacuum gauges, e.g. cold cathode vacuum gauges such as Penning vacuum gauges or extractor ionization gauges, may be used as first/second sensors 15a, 15b as well.

The pressure p_{c} of the calibration gas 7 determined by the first pressure sensor 15a may be used in the control unit 13 for determining a flow rate Q_{c} of the calibration gas 7 (provided that the flow rate Q_{c} of the calibration gas 7 is not determined directly by the quartz crystal microbalance 15b). In general, the flow rate Q_{c} of the calibration gas 7 should be as constant as possible during the calibration process for quantitative mass spectra. The control unit 13 may be adapted to control or to regulate (in closed-loop control) the flow rate Q_{c} of the calibration gas 7. The flow rate Q_{c} of the calibration gas 7 or the pressure p_{c} of the calibration gas 7 may be used in the calibration of the mass spectrometer 1, as will be explained in detail further below.

In the calibration process, a calibration of the mass scale of the mass spectrometer 1 is performed. In the present example, the calibration involves a correlation between the quadrupole voltages applied to the quadrupole analyzer 10 and the mass-to-charge ratios of the known atomic mass(es) of the constituents of the calibration gas 7 that are detected by the detector 12. The known masses, resp., mass-to-charge ratios, of the peaks of the constituent(s) of the calibration gas 7 in the mass spectrum of the calibration gas 7 serve as a mass scale by which the peaks of the (unknown) constituents of the sample gas 4 that are present in the mass spectrum of the sample gas 4 may be assigned to their correct mass-to-charge ratios.

In addition to the identification of specific constituents of the sample gas 4, for quantitative measurements, the sensitivity/signal intensity of the mass spectrometer 1 should be calibrated as well.

For this purpose, in a first step, for a given mass-to-charge ratio k of the source material 10, in the present example gold (¹⁹⁷Au, k=197), a background pressure p₀ in the mass spectrometer 1 (i.e. without the calibration gas 7 or the sample gas 4 being present) is determined using the first and/or the second pressure sensor 15a,b. In addition to the background pressure pₒ, a background signal intensity Bₖ measured by the detector 12 at the mass-to-charge ratio k=197 a.m.u. is determined. In a subsequent step, the calibration gas 7 is introduced into the ionization region 5 and the pressure p₁ (or equivalently, p_{c}) is measured by the pressure sensors 15a,b. The signal intensity Sₖ of the ionized calibration gas 7 at a mass-to-charge ratio or a.m.u. of k=197 is determined by the detector 12.

In a subsequent step, the sensitivity Kₖ of the mass spectrometer 1 for the mass-to-charge ratio k=197 is determined by calculating the ratio of the difference between the signal intensities in the first and second step Sₖ−Bₖ at the mass-to-charge ratio k and the difference between the pressure values p₁−p₀ in the second and in the first step (see also the article by Robert E. Ellefson cited above):

Kₖ=(Sₖ−Bₖ)/(p₁−p₀) (1)

In this way, the sensitivity Kₖ for the mass-to-charge ratio k=197 (i.e. for Au) is determined. It is advantageous to calibrate the mass spectrometer 1 for at least one further value of the a.m.u. (or, equivalent, m/z-rato) that is comparatively small, e.g. for k=27 (i.e. Al). The sensitivity of the mass spectrometer 1 for k=27 can be determined in the way indicated above by using a further evaporation unit for evaporating Al as a source material 10.

In order to determine a pressure increase in the ionization region 5 or in the mass spectrometer 1 when the thermal evaporation source 9 of the calibration unit 6 is heated up, the mass spectrometer 1 of FIG. 1 has a moveable cover 16. The moveable cover 16 is arranged close to the calibration unit 6 and can be moved from a first position in which the cover 16 does not block the line of sight 14a between the source material 10 and the ionization region 5 and to the pressure sensors 15a,b and a second position in which the movable cover 16 blocks the line of sight 14a. In the present example, the moveable cover 16 can be moved between the two positions in a translational movement, as is indicated by a double-headed arrow in FIG. 1. By blocking the respective line of sight 14a,b, the at least one pressure sensor 15a,b can be used to determine a pressure increase in the vacuum system of the mass spectrometer 1 when the evaporation source 6 is heated up, without at the same time measuring the pressure increase due to the calibration gas 7. The pressure increase due to the temperature increase of the evaporation source 9 may possibly be taken into account for the calibration of the mass spectrometer 1.

The calibration described above with respect to FIG. 1 may also be performed in a mass spectrometer 1 having an electrical Fourier-Transform ion trap 18 shown in FIG. 2. The mass spectrometer 1 of FIG. 2 has an inlet (not shown) for supplying the sample gas 4 to the ionization region 5 via a line of sight 14b. The ionization region 5 essentially corresponds to the center of the ion trap 18. FIG. 2 shows the mass spectrometer 1 in a state where a calibration unit 6, more precisely an evaporation unit 9 thereof, is activated for evaporating a source material 10, being gold in the present example. In FIG. 2, the calibration gas 7 is shown in the ionization region 5 together with the line of sight 14a leading from the calibration unit 6 to the ionization region 5. In the example of FIG. 2, the evaporation source 9 is a pulsed layer deposition, PLD, source. However, rather than using a PLD source 9, a thermal evaporation source as shown in FIG. 1 may be used as well. Moreover, in the example of FIG. 1, rather than using a thermal evaporation source 9, a PLD source or another type of ionization source may be used as well.

In the electrical FT ion trap 18 of FIG. 2, ions 7a, 7b of the calibration gas 7 are trapped between a ring electrode 19 and a first and second cap electrode 20a, 20b. For storing the ions 7a, 7b in the ion trap 18, an RF signal generation unit 21 generates a radio frequency signal V_{RF} that is provided to the ring electrode 19. Two excitation units 22a, 22b each generate an excitation signal S1, S2 provided to a respective cap electrode 20a, 20b to excite the ions 7a, 7b to effect oscillations. An oscillation frequency of the ions 7a, 7b in the ion trap 18 depends on a mass-to-charge ratio of the ions 7a, 7b. Two measurement amplifiers 23a, 23b amplify a respective measurement current caused by the oscillations. An ion signal uᵢₒₙ(t) is generated from a difference between the two measurement currents. A detector 12 that comprises a FFT (“fast Fourier transform”) spectrometer serves to perform a Fourier transformation of the ion signal uᵢₒₙ(t) and for determining mass spectrometric data in the form of mass spectra 25. The mass spectra 25 are indicative of the number of excited ions 7a, 7b in dependence of their mass-to-charge ratio m/z. In other words, the mass spectra 25, resp., the mass-spectrometric data 25 is indicative of the mass-to-charge distribution of the ions 7a, 7b in the calibration gas 7.

In the example of FIG. 2, the calibration gas 7 is introduced into the ion trap 18 in an electrically neutral state. The mass spectrometer 1 has an ionization unit 8 to ionize at least part of the neutral calibration gas 7 introduced into the ion trap 18 in the ionization region 5. In the present example, the ionization unit 8 comprises an electron gun (e.g. 70 eV or another suitable ionization-energy) for electron beam ionization of the neutral calibration gas 7 introduced into the ion trap 18. As in the example of FIG. 1, the electron beam 8a intersects the line of sight 14a that leads from the calibration unit 6 to the ionization region 5. It will be understood that other types of ionization units 8 may be used in the mass spectrometers 1 of FIG. 1 and of FIG. 2 as well, using e.g. an inductively coupled plasma, a glow discharge ionization, etc.

Previous to the detection, the ions 7a, 7b may be at least once selectively excited according to their mass-to-charge ratio m/z, for instance, by means of a SWIFT (stored waveform inverse Fourier transform) excitation. The SWIFT excitation may in particular serve to eliminate ions 7a, 7b having specific mass-to-charge ratios from the ion trap 18. In particular, ions 7a, 7b of a buffer or background gas may be eliminated from the ion trap 18, thus allowing the detection of minute traces of ions 7a, 7b of gaseous species of the calibration gas 7. The mass spectrometer 1 shown in FIG. 2 also comprises an evaluation unit 13 that controls the mass spectrometer 1, in particular the calibration process, as explained above with reference to the mass spectrometer 1 of FIG. 1.

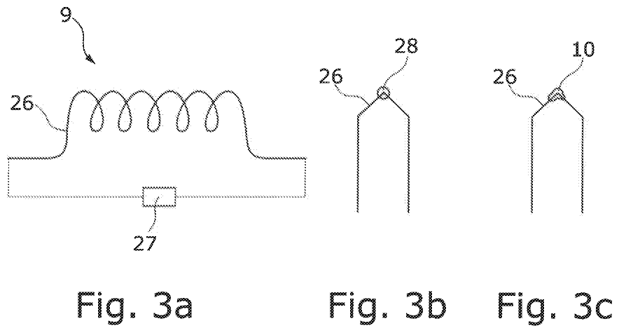

FIG. 3a shows the evaporation source 9 of FIG. 1 in greater detail. The evaporation source 9 has a filament 26 and a voltage source 27. The voltage source generates an (adjustable) voltage for passing a current through the filament 26 to heat up the filament 26 to temperatures of 1000° C. or more. In the present example, the filament 26 is made of tungsten (W) and has a diameter of about 0,3 mm to 0,5 mm. As can be gathered from FIG. 3b,c, a gold wire 28 is hooked to the filament 26. By heating the filament 26 to temperatures above the melting point of the gold wire 28, the latter melts and flows along the filament 26, thus providing a coating, e.g. in the form of droplets of the source material 10 as shown in FIG. 3c. It will be understood that wires made of other (metallic) materials such as copper or the like may be used instead of gold to provide a source material 10 that can be evaporated when passing a current through the filament 26.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A mass spectrometer, comprising:
a gas inlet adapted to supply a sample gas to be ionized to an ionization region of the mass spectrometer,
a calibration unit adapted to supply a calibration gas to be ionized to the ionization region,
an ionization unit adapted to ionize the sample gas and/or the calibration gas in the ionization region, wherein
the calibration unit comprises at least one evaporation source for generating the calibration gas by evaporating a source material.

2. The mass spectrometer according to claim 1, wherein the source material and the ionization region are arranged along a line of sight.

3. The mass spectrometer according to claim 1, wherein the evaporation source is a thermal evaporation source, preferably a resistive evaporation source, an electron beam evaporation source or an effusion evaporation source.

4. The mass spectrometer according to claim 3, wherein the resistive evaporation source comprises a heated filament that is at least partially coated with the source material.

5. The mass spectrometer according to claim 1, wherein the evaporation source is a pulsed laser deposition, PLD, evaporation source.

6. The mass spectrometer according to claim 1, wherein the source material is a metal, preferably selected from the group consisting of: Al, Co, Mn, Bi, Ni, Fe, Cu and precious metals, in particular Au.

7. The mass spectrometer according to claim 1, wherein the source material is selected from the group consisting of: metal nitrides and metal oxides, in particular of Tantalum, Vanadium, Tungsten, Rhenium, or Yttrium.

8. The mass spectrometer according to claim 1, further comprising:
at least one sensor, preferably for determining a pressure of the calibration gas, wherein the sensor is preferably arranged along a line of sight to the ionization region and/or along a line of sight to the source material.

9. The mass spectrometer according to claim 8, wherein the sensor is a pressure sensor, preferably an ionization vacuum gauge, more preferably a cold cathode vacuum gauge, in particular a Penning vacuum gauge, or a hot cathode vacuum gauge, in particular a Bayard-Alpert vacuum gauge or an extractor ionization gauge.

10. The mass spectrometer according to claim 9, wherein the pressure sensor or a control unit of the mass spectrometer is adapted for determining a flow rate of the calibration gas based on the pressure of the calibration gas determined by the pressure sensor.

11. The mass spectrometer according to claim 8, wherein the sensor is a quartz crystal microbalance, preferably for determining a flow rate of the calibration gas.

12. The mass spectrometer according to claim 8, further comprising: a movable cover for blocking a line of sight between the source material and the ionization region and/or a line of sight between the source material and the pressure sensor.

13. The mass spectrometer according to claim 1, wherein the ionization unit is an electron ionization source.

14. The mass spectrometer according to claim 1, further comprising:
an ion trap for storing ions of the sample gas and/or of the calibration gas, wherein the ionization region is formed inside of the ion trap.

15. A method for calibrating a mass spectrometer, comprising:
generating a calibration gas by evaporating a source material in at least one evaporation source of the mass spectrometer,
supplying the calibration gas to an ionization region and ionizing the calibration gas in the ionization region,
detecting the ionized calibration gas in a detector of the mass spectrometer, and
calibrating the mass spectrometer based on the detected ionized calibration gas.

16. The method according to claim 15, wherein the step of calibrating the mass spectrometer comprises:
determining a sensitivity of the mass spectrometer based on a signal intensity of the detector when detecting the ionized calibration gas and based on a pressure detected by at least one pressure sensor when supplying the calibration gas to the ionization region.

17. The method according to claim 15, further comprising:
before and/or after supplying the calibration gas to the ionization region:
coating surfaces of vacuum components in the mass spectrometer with a getter material for the source material.
